(19) United States
(12) Patent Application Publication
(10) Pub. No.: US 2005/0278687 A1
(43) Pub. Date: Dec. 15, 2005

(54) System and method for facilitating computer software features requested by end users

(76) Inventor: Suresh Madhavan, Foster City, CA (US)

Correspondence Address: PERKINS COIE LLP, P.O. BOX 2168, MENLO PARK, CA, 94026, US

(21) Appl. No.: 11/142,828

(22) Filed: May 31, 2005

Related U.S. Application Data
(60) Provisional application No. 60/575,775, filed on May 28, 2004.

(51) Int. Cl. G06F 9/44

(52) U.S. Cl. 717/100

(57) ABSTRACT

A technique for providing end user support involves allowing an end user to express wishes or requirements to a software developer or support organization about a software application. In a non-limiting embodiment, a system may include technology for (1) sensing a user's business context and application context; (2) allowing the user to express wishes or requirements about the software application or its use in the user's business, in a manner that ensures that a software developer associated with the software application receives these wishes, requests, and requirements; and (3) funneling such requests through a standardized process so that the user may receive the benefits of those requests in a coordinated manner in a relatively short time.

### CROSS-REFERENCE TO RELATED APPLICATIONS

This application claims priority under 35 USC 119(e) to provisional application No. 60/575,775 filed May 28, 2004.

### BACKGROUND

Exemplary embodiments of the invention relate to computer systems. Specific embodiments relate to providing software features to end users.

End users of computer programs occasionally have problems or suggestions related to programs. Typically, these problems or suggestions may be addressed by providing a technical support phone number or email address to which an end user may submit questions or comments. Technical support personnel receive the questions or comments and reply to the end user in a manner that is presumably helpful.

Unfortunately, this technical support system does not enable the end user to have direct input in the evolution and improvement of applications they use. Technical support systems are typically not direct channels of communication between the end user and a software development team associated with the program, which may reduce the ability of the software development team to accelerate innovation in the direction a customer demands.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for providing end user support involves allowing an end user to express wishes or requirements to a software developer or support organization about a software application. In a non-limiting embodiment, the end user has the ability, via user interfaces and processes that are driven by the end user's needs, to see and manipulate data and information. This may obviate the need for a committee of consultants and internal “IT power users.” In another non-limiting embodiment, real-time software development facilitates jumping from concept to requirements to a delivered prototype with speed and precision.

In a non-limiting embodiment, computer software applications may be delivered to end users via a public network such as the Internet or a private network such as a corporate Intranet. In a non-limiting embodiment, a system may include technology for (1) sensing a user's business context and application context; (2) allowing the user to express wishes or requirements about the software application or its use in the user's business, in a manner that ensures that a software developer associated with the software application receives these wishes, requests, and requirements; and (3) funneling such requests through a standardized process so that the user may receive the benefits of those requests in a coordinated manner in a relatively short time.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts a flowchart according to a non-limiting embodiment.

FIG. 2 depicts a system according to a non-limiting embodiment.

FIGS. 3A to 5B depict screenshots that are used by way of example but not limitation to show aspects of several exemplary embodiments.

FIG. 6 depicts a flowchart of a method according to a non-limiting embodiment.

FIG. 7 depicts a conceptual view of a system according to a non-limiting embodiment.

In the figures, similar reference numerals may denote similar components.

### DETAILED DESCRIPTION

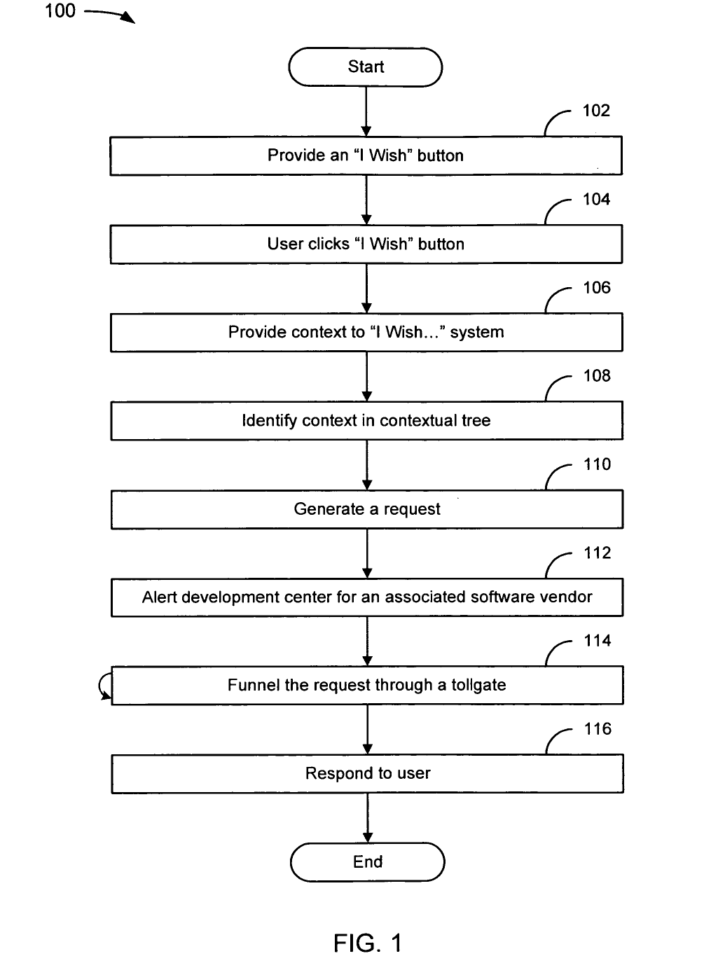

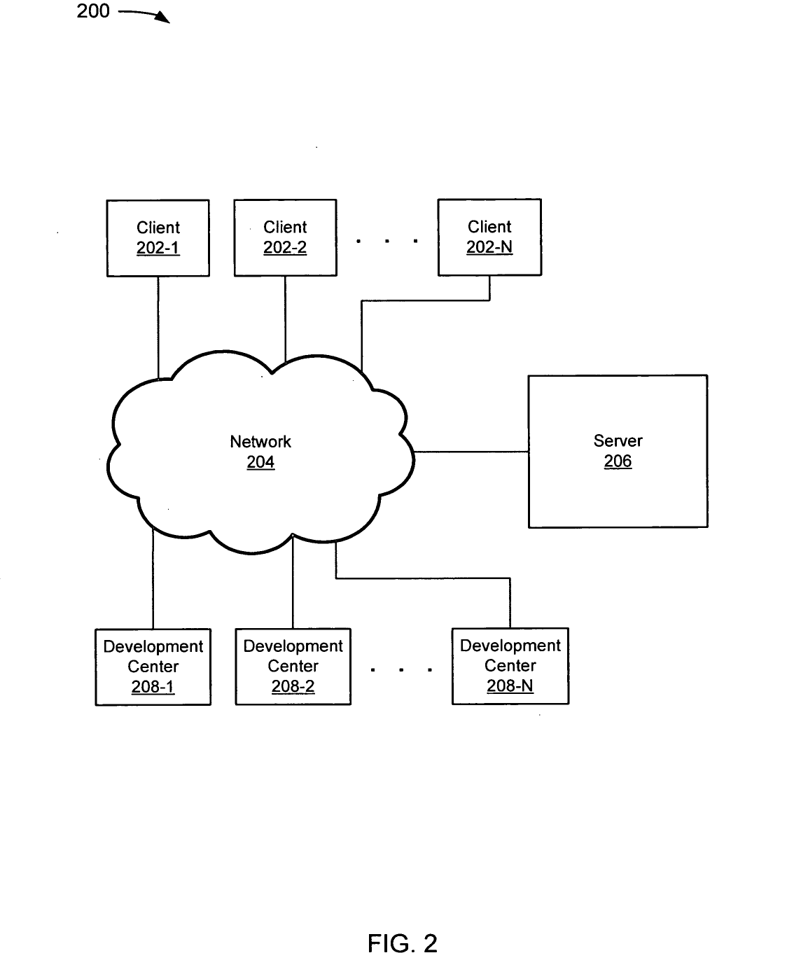

FIG. 1 depicts a flowchart 100 according to a non-limiting embodiment. In the example of FIG. 1, the flowchart 100 starts at block 102 where an “I Wish” button is provided on a user interface screen. The “I Wish” button may be, by way of example but not limitation, a link or a button on a user interface or on a web page associated with an application or service offering. In various non-limiting embodiments, the “I Wish” button may be provided on a graphical user interface (GUI) in standard enterprise software and/or any type of software application operable using a GUI. In a non-limiting embodiment, the “I Wish” button is purposely ubiquitous so that a user can click on the button at any time.

In the example of FIG. 1, the flowchart 100 continues at block 104 where a user clicks the “I Wish” button. By way of example but not limitation, a user may click on the “I Wish” button by moving a cursor over the button and clicking a mouse button, or by performing some other standard or pre-determined action designed to select the “I Wish” button. In a non-limiting embodiment, clicking the “I Wish” button opens an email, network-deliverable form, or other electronic communication medium on which the user may enter a wish, request, or requirement. In another non-limiting embodiment, selecting the “I Wish” button may invoke one or more of the following responses:
1) An agent on the phone asking the wish, or details regarding the wish;
2) an email pop-up, or email, that allows the user to enter the wish and send it off;
3) a form pop-up that allows the user to fill out details of the wish;
4) a status report that provides the user with the status of previous wishes;
5) a status report that provides the user with the status of similar wishes that have been implemented;
6) other events.

In the example of FIG. 1, the flowchart 100 continues at block 106 where context associated with the operating environment of the user is provided to an “I Wish . . . ” system. In a non-limiting embodiment, the “I Wish . . . ” system is effective to recognize the context associated with the operating environment. Context may or may not include a user's working context in relation to the business function that the user is filling at the time the “I Wish” button was selected. By way of example but not limitation, context may include a program name, an identifier of a screen or GUI interface from which the “I Wish” button was selected, a user name, user account information, or other user information, an environment constant or variable, application context that indicates functionalities that the user was accessing at the time the “I Wish” button was selected or had accessed prior to selecting the “I Wish” button, application context that indicates functionalities that the user was utilizing at the time the “I Wish” button was selected or had utilized prior to selecting the “I Wish” button, recent history of business contexts that the user had traversed before the user reached the context at the time the “I Wish” button was selected, recent history of the application contexts and the sequence of access to those applications prior to reaching the application from which the “I Wish” button was selected, or other data. Non-limiting embodiments may further include sensing or determining the context in which the user is working. In addition to the determined context, embodiments of the invention may further list all the contexts (potentially anywhere in the system environment) to which the determined context is directly related. Embodiments of the invention may also sense decisions, issues, and risk matters being considered by the user concurrently with or immediately prior to the time that the user selected the “I Wish” button.

In the example of FIG. 1, the flowchart 100 continues at optional block 108 where context is identified in a contextual tree. A contextual tree may or may not be defined as one of many trees in a larger collection of trees called a “project,” which may be defined as one of many projects in a business base. The business base may or may not be one of many business bases in a computer system environment. The working contexts may or may not be related to other people and their roles and their responsibilities in this selected context, as well as to definitional dictionaries structured in a hierarchical taxonomy that further ascribes additional meaning to the context. The block 108 is optional because, in alternative embodiments, the context may be identified in some other manner.

In the example of FIG. 1, the flowchart 100 continues at optional block 110 where a request is generated. The request may or may not include some or all of the context information of the wish. The request may or may not include additional information associated with a development center, agent, or other person, organization, or component. The block 110 is optional because the wish may, in a non-limiting embodiment, already be in the form of a request.

In the example of FIG. 1, the flowchart 100 continues at block 112 where a development center for an associated software vendor is alerted to the wish. In a non-limiting embodiment, the wish may be associated with multiple development centers and/or multiple software vendors. In another non-limiting embodiment, the wish is sent to one or more processing centers at one or more organizations so that priorities can be assigned and reassigned. Wishes received at a development center should be classified, or classifiable according to one or more of priority, business classification, software application classification, user role and responsibility, and/or other factors.

In the example of FIG. 1, the flowchart 100 continues at block 114 where the wish is funneled through a tollgate. In a non-limiting embodiment, the wish is funneled through a graduated set of tollgates that may or may not mature the wish into an implementation. One or more tollgates may be bypassed or skipped depending upon determinations made at prior tollgates, priorities, or other considerations. By way of example but not limitation, the graduated set of tollgates may include tollgates identifiable as triage, definition, development, monitoring, and deployment. The triage tollgate, which may or may not be combined with block 112, may involve identifying an appropriate human or artificial agent to which the wish should be sent. The definition tollgate may or may not be combined with block 108. When the wish passes through the triage tollgate to an appropriate agent, the wish may be defined in a manner that facilitates development of a solution. The development tollgate may or may not include developing software code in response to the wish. The monitoring tollgate may or may not include monitoring developed code to ensure that the software behaves within acceptable parameters. The deployment tollgate may or may not include deploying the modified software to the user's system, or to other systems as, by way of example but not limitation, a bug fix or update.

At points within block 114, an agent may or may not search for similar or identical wishes and requests from the user, an associated organization, and/or other organizations. The wishes and requests may or may not be consolidated into a group having similar attributes. In a non-limiting embodiment, the group may be made available to one or more development centers, development communities, and/or associated organizations.

In another non-limiting embodiment, an agent may or may not validate and rank users who propose wishes, requests, and requirements, based upon past wishes from the users, and the disposition of the past wishes. In another non-limiting embodiment, the “I Wish . . . ” system may facilitate access to the process of fulfilling wishes and requests so that the user or an administrator associated with the user may monitor the progress throughout some or all of the process.

In the example of FIG. 1, the flowchart 100 ends at optional block 116 where a wish coordinator responds to the user. In an embodiment, the block 116 may occur at any time in the flowchart 100. By way of example but not limitation, the wish coordinator may respond to the user before block 114, or after passing through one or more of the tollgates at block 114. The wish coordinator may include a human agent, an automated software agent, and/or a partially automated software process. The wish coordinator may or may not be associated with the software vendor, with a software developer, or the user. In a non-limiting embodiment, the wish coordinator responds to the user personally to let them know about the status of their wish. The wish coordinator may provide information such as, by way of example but not limitation:
1) The wish will be implemented (“granted”) and in what timeframe;
2) the wish is already in the pipeline (“funnel”) because of other similar wishes;
3) the wish should be coordinated with the activities of certain other groups or processes in the user's organization;
4) the wish conflicts with certain requirements that have been established, and moving forward may require that these conflicts be resolved;
5) the wish is technically inconsistent.
   Other appropriate responses should be apparent to those skilled in the art with this reference before them. In addition, the wish coordinator may provide the status of prior wishes, requests, and requirements and the existence of other wishes similar to the ones the user has proposed. An administrator may be provided with the status of multiple user proposals.

The “I Wish” process has been shown to cause a wild-fire increase in commitment and adoption by users and at the corporate level. A Wish Icon, or the “I Wish” button, may be bundled as part of license pricing of underlying software, thereby effectively eliminating the need for customer organizations to write complex specifications, find budgets, and obtain consensus prior to engaging expensive consultants. Implementation of the Wish Icon provides the vendor and the customer a powerful network that binds them together and creates a level of daily intimacy that traditional engagements cannot support. It reduces the cost of business development for the vendor because the vendor has excellent visibility with transparency into the customer and user's intention. Software companies are increasingly aware of the need to improve their image with clients and bring faster better and cheaper performance solutions. The “I wish” approach is a powerful one that others will want to emulate. For companies that offer services for a price, this is a powerful way to build a brand and loyalty to the brand.

FIG. 2 depicts a system 200 according to a non-limiting embodiment. In the example of FIG. 2, the system 200 includes clients 202-1 to 202-N (collectively referred to hereinafter as clients 202), a network 204, a server 206, and development centers 208-1 to 208-N (collectively referred to hereinafter as development centers 208).

The clients 202, server 206, and development centers 208 may be coupled to the network 204 in a conventional (or later developed) manner, such as described later with reference to FIG. 8. The clients 202 may be part of the same enterprise and coupled to the same network 204, which, in turn, may or may not be in communication with a WAN or the Internet. Alternatively, the clients 202 may be in entirely different enterprises. The network 204 may be any conventional (or later developed) network, such as the Internet, and such as described later with reference to FIG. 8. In an alternative, the server 206 may include multiple servers. The server 206 may be part of the same enterprise as the clients 202, or part of a different enterprise. The development centers 208 (or a subset thereof) may be part of the same enterprise as the clients 202, or part of a different enterprise. The development centers 208 (or a subset thereof) may be part of the same enterprise as the server 206. The development centers 208 may be part of the same enterprise as one another, or part of different enterprises.

In operation, in a non-limiting embodiment, an end user at one of the clients 202 submits a wish, request, or requirement to the server 206 through the network 204. The server 206 determines which of the development centers 208 (or which subset thereof, or whether all of the development centers 208) are the appropriate target for the wish, request, or requirement. By way of example but not limitation, the server 206 may determine that a wish is associated with a first program, or process within the first program, and assign the wish to one or more of the development centers 208 associated with the first program, or process within the first program. Alternatively, all wishes could be forwarded to one or more “triage” development centers 208 where the wishes are categorized and sent to other development centers 208 based upon the categorization.

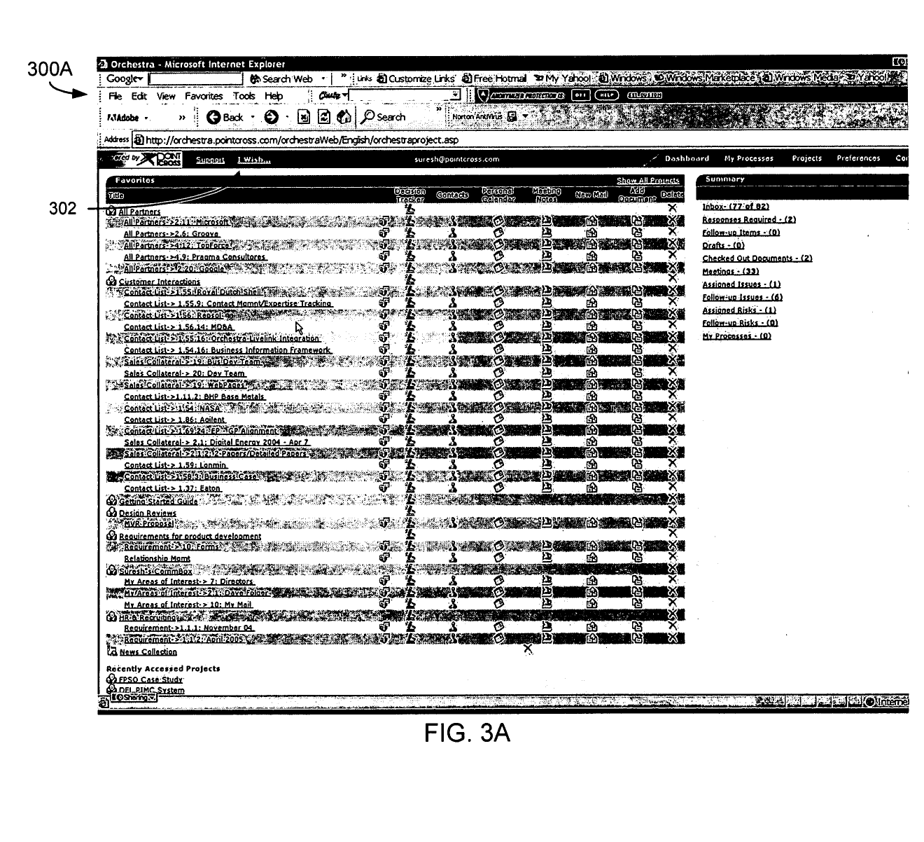

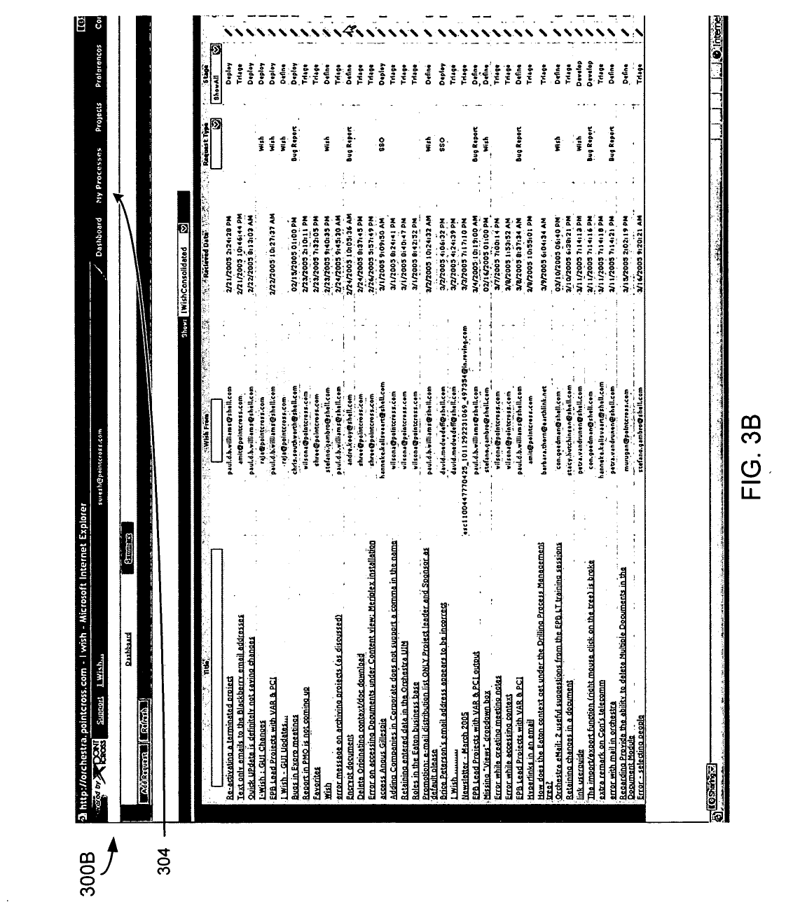

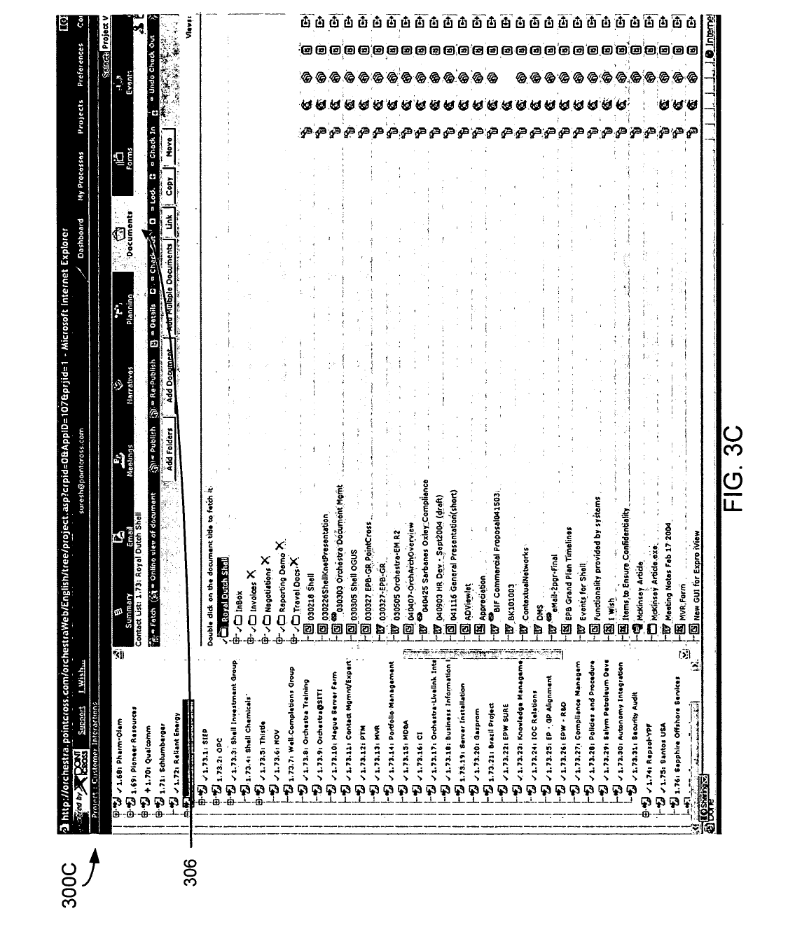

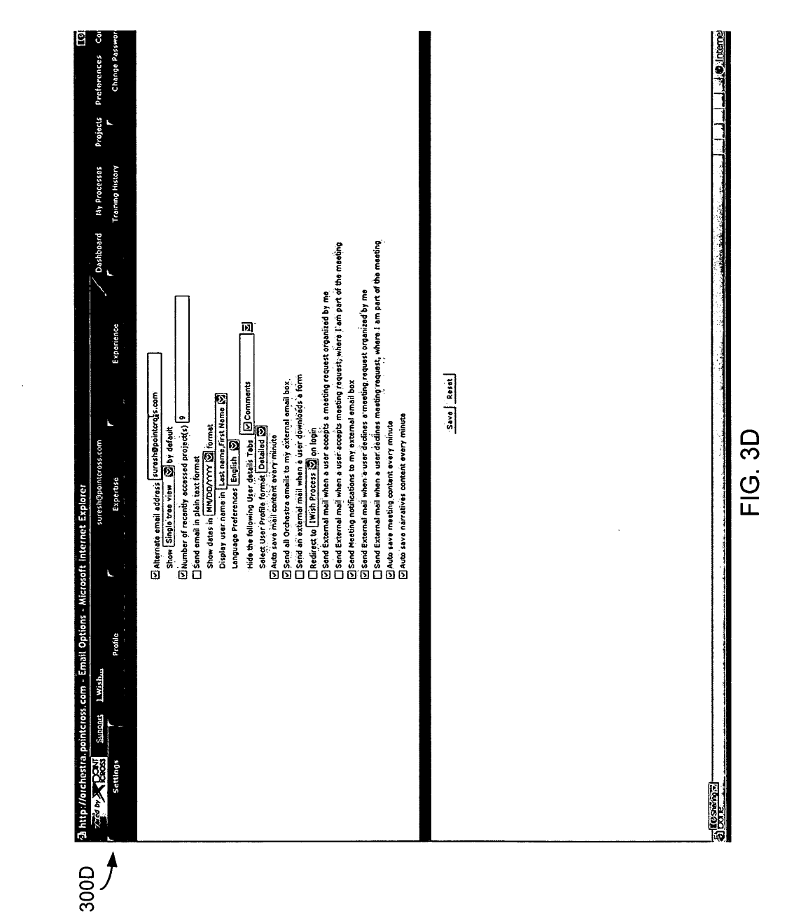

FIGS. 3A to 5B depict screenshots that are used by way of example but not limitation to show aspects of several exemplary embodiments. FIG. 3A depicts a screenshot 300A of a browser window in which a web page is displayed. In the example of FIG. 3A, an “I Wish” button 302 is displayed within the web page. The “I Wish” button 302, in alternative embodiments, may be displayed anywhere within the web page or in the browser window, such as, by way of example but not limitation, the tool bar or menu bar. In other alternatives, the “I Wish” button 302 could be displayed in a separate window, or implemented as a physical button that is attached to a computer system by way of, for example, an I/O port (not shown). In any of these embodiments, when the “I Wish” button 302 is pressed, a wish, request, or requirement is sent after a user enters data associated with the wish, request, or requirement (if necessary).

FIG. 3B depicts a screenshot 300B of a browser window in which a web page is displayed. In the example of FIG. 3B, the web page includes a menu 304. For illustrative purposes, the “My Processes” tab has been selected. The web page includes information about several processes. The information includes title, originator of the process (e.g., email address), date received, type of request (e.g., wish, bug report, SSO), and stage (e.g., triage, define, develop, monitor, deploy). The amount of information may be decreased or increased depending upon the design of the “I Wish . . . ” system, priorities, requirements, desired results, or desired level of detail or precision.

FIG. 3C depicts a screenshot 300C of a browser window in which a web page is displayed. In the example of FIG. 3C, for illustrative purposes, the “Projects” tab has been selected from the menu 304 (see FIG. 3B). The web page includes a task bar 306. For illustrative purposes, the “Documents” tab has been selected. Using the task bar 306, information related to a contextual tree, clients, processes, technicians, and other items may be accessed. The amount of information may be decreased or increased depending upon the design of the “I Wish . . . ” system, priorities, requirements, desired results, or desired level of detail or precision.

FIG. 3D depicts a screenshot 300D of a browser window in which a web page is displayed. In the example of FIG. 3D, for illustrative purposes, the “Preferences” tab has been selected from the menu 304 (see FIG. 3B). The web page includes information about settings, profile, expertise, experience, training history, and other items for a user of the system. The amount of information may be decreased or increased depending upon the design of the “I Wish . . . ” system, priorities, requirements, desired results, or desired level of detail or precision.

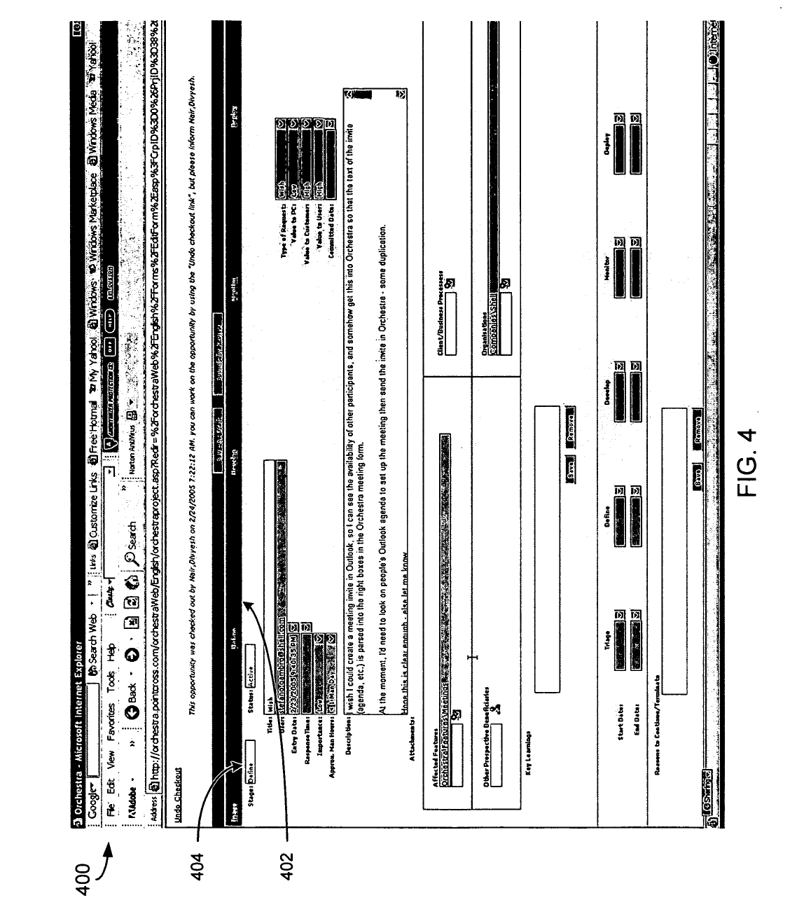

FIG. 4 depicts a screenshot 400 of a browser window in which a web page is displayed. In the example of FIG. 4, the browser window shows information related to a wish. The browser window includes a task bar 402. Using the task bar 402, data associated with a wish or request may be shown at various stages of the “I Wish . . . ” process. In this non-limiting embodiment, the stages include “Triage”, “Define”, “Develop”, “Monitor”, and “Deploy”.

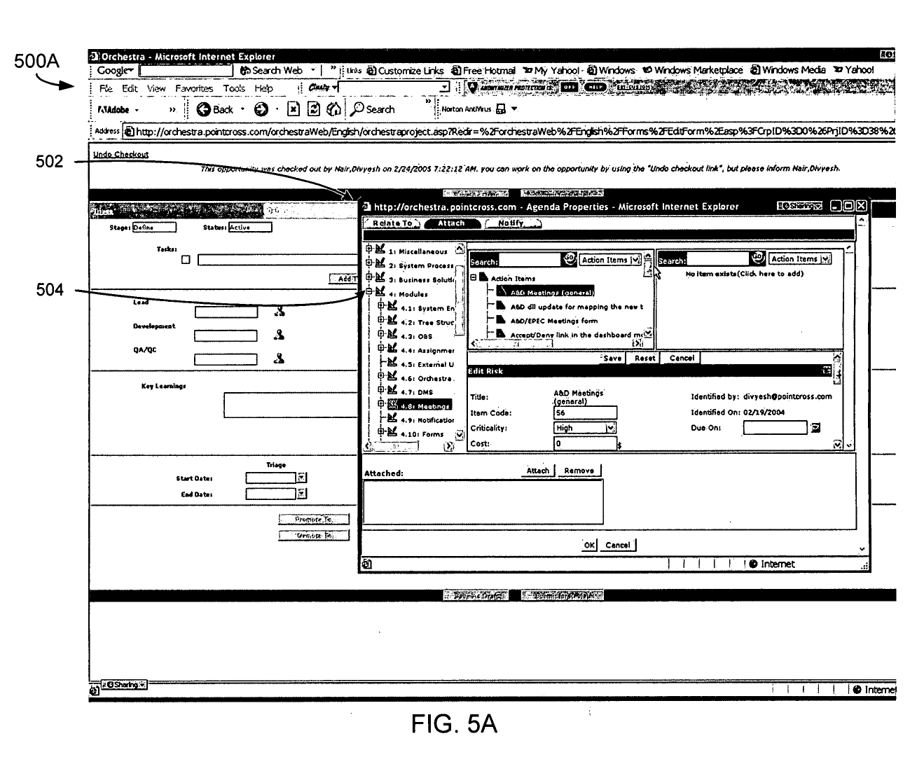

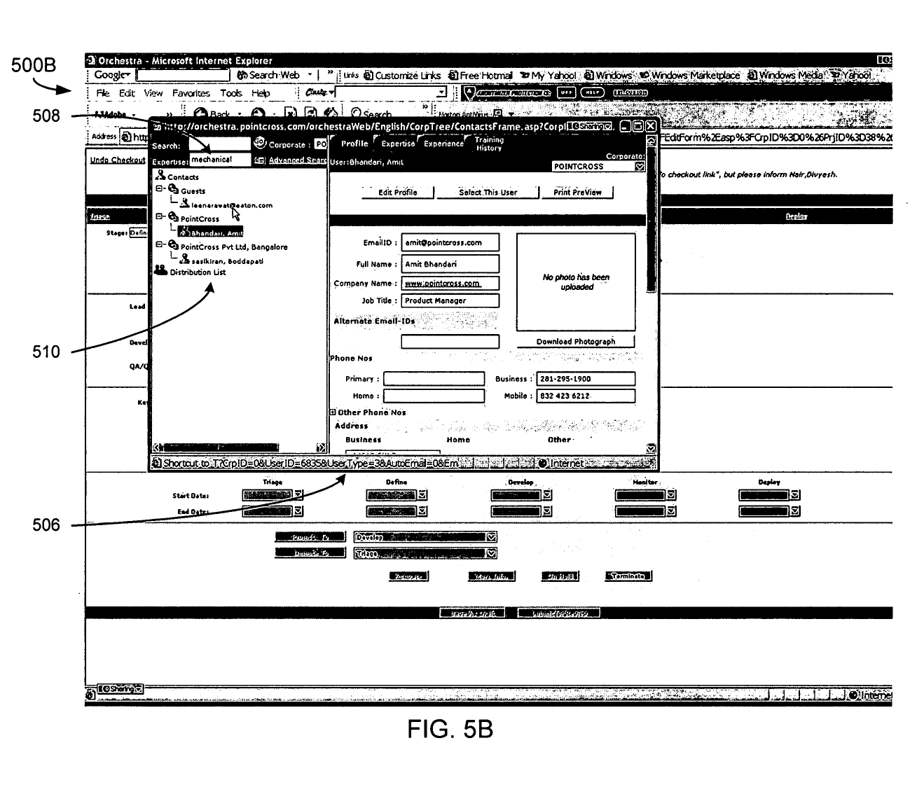

The stage box 404 indicates that the exemplary wish of screenshot 400 is in the “Define” stage. In the “Triage” stage, relevant date may or may not have been entered in the various other data boxes by an agent, which may have been a human agent or an artificial agent. The agent may or may not make use of contextual information provided in the original wish to generate a request. For illustrative purposes, actions associated with the “Define” stage are described with reference to FIGS. 5A and 5B.

FIG. 5A depicts a screenshot 500A of a browser window in which a web page similar to that of FIG. 4 is displayed. In addition, a pop-up window 502 is shown. In the pop-up window, a contextual tree 504 is shown. In the “Define” stage, the contextual tree may be traversed by an agent based on the context of the request. The contextual tree may have a level of detail that is appropriate for a given application. It may be possible to continue to drill down into the contextual tree, creating new subcategories if necessary, until a desired level of precision is achieved.

FIG. 5B depicts a screenshot 500B of a browser window in which a web page similar to that of FIG. 4 is displayed. In addition, a pop-up window 506 is shown. In the “Define” stage, an appropriate technician may be selected for action at subsequent stages. In the example of FIG. 5B, “mechanical” expertise is selected in the Expertise box 508, and an appropriate technician is selected from contacts tree 510. Other information related to the technician is shown in the pop-up window 506, as well.

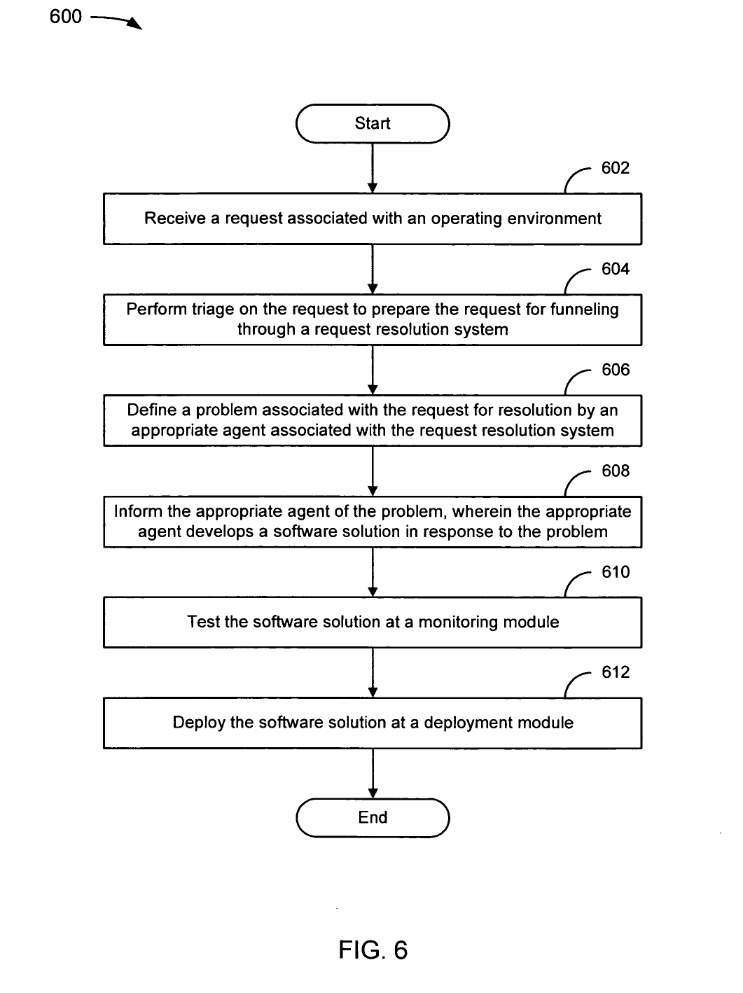

FIG. 6 depicts a flowchart 600 of a method according to a non-limiting embodiment. In the example of FIG. 6, the various stages of the “I Wish . . . ” system are depicted by way of example but not limitation. In the example of FIG. 6, the flowchart 600 starts at block 602 where a request associated with an operating system is received. By “associated with an operating environment,” what is meant is that the request includes contextual information associated with an operating environment.

In the example of FIG. 6, the flowchart 600 continues at block 604 where triage is performed on the request to prepare the request for funneling through a request resolution system. When the request is received, an email message or other feedback may inform the requestor that the request has been received. The triage may include, by way of example but not limitation, setting importance, setting priority, setting committed dates, setting the type of request, and other data. The triage start date and end date may also be entered, and user information associated with the requestor or the technician performing the triage. Triage may be performed by a human, an artificial agent, or a partially automated procedure.

Triage, as used herein, is a process for sorting requests into groups so that the request can receive better care. The groups may be associated with a particular category, such as a field of endeavor. Alternatively, or in addition, the groups may be separated according to priority, value, time requirements to address a problem, if known at this stage, or according to other characteristics. It may be noted that occasionally requests are such that further stages become unnecessary, such as when the agent knows how to address the request with a proper solution without further processing. In addition, it may be possible to skip certain stages if they are known to be unnecessary. For example, data and context associated with a request may be such that the request need not be sent to a definition stage, so the definition stage is skipped, a problem defined in triage, and the problem sent directly to a development stage.

During or at the completion of the triage stage, an email message or other feedback may be sent to the requestor. The feedback may include, by way of example but not limitation, an estimate of the time required to solve the problem (if known at the triage stage), a summary of contextual information, a request for further information, or other feedback.

In the example of FIG. 6, the flowchart 600 continues at block 606 where a problem associated with the request is defined for resolution by an appropriate agent associated with the request resolution system. The definition may include, by way of example but not limitation, drilling down into a contextual tree to clearly define the problem, selecting an appropriate agent who has relevant skills, setting due dates, grouping the problem with other similar problems, associating the problem with other requests from the same user or the same enterprise, and other actions. The definition start date and end date may also be entered, and user information associated with the requester or the technician performing the defining. Definition may be performed by a human, an artificial agent, or a partially automated procedure.

The defining stage, among other things, helps to ensure that duplication of effort is reduced. It may be possible to identify similar problems that have already been assigned to an appropriate agent. If the similar problems are in the “Develop”, “Monitor”, or “Deploy” stages, then the defined problem can be assigned directly to those stages, possibly skipping intervening stages. Stages could be skipped for other reasons, as well, such as by solving relatively simple problems at the definition stage, obviating the need to assign the problem for development in a development stage.

During or at the completion of the defining stage, an email message or other feedback may be sent to the requestor. The feedback may include, by way of example but not limitation, an estimate (or updated estimate) of the time required to solve the problem, a summary of contextual information, a request for further information, the appropriate agent name or identifying information, the development center where a solution to the problem will be developed, or other feedback.

In the example of FIG. 6, the flowchart 600 continues at block 608 where the appropriate agent is informed of the problem. The appropriate agent is supposed to develop a software solution in response to the defined problem, if necessary. The development start date and end date may be entered, along with other relevant information associated with the appropriate agent, the problem, or the software solution. The agent may be a human (e.g., a computer programmer), an artificial agent, or a partially automated procedure. Feedback may or may not be provided at any time in the development stage to the requestor or requestors associated with the problem.

In the example of FIG. 6, the flowchart 600 continues at block 610 where the software solution is tested at a monitoring module. The testing may be accomplished by the agent who developed the software solution or by some other agent. The agent performing the monitoring may be a human, an artificial agent, or a partially automated procedure. If it is determined that the software solution has problems, the problem may be sent back to the development stage. Feedback may or may not be provided at any time in the monitoring stage.

In the example of FIG. 6, the flowchart 600 continues at block 612 where the software solution is deployed at a deployment module. The deployment may be by the appropriate agent, a supervisor, or some other agent. Again, the agent may be a human, artificial agent, or partially automated procedure. Feedback may be provided at any time in the deployment stage, and particularly when a request has been resolved and the software solution deployed.

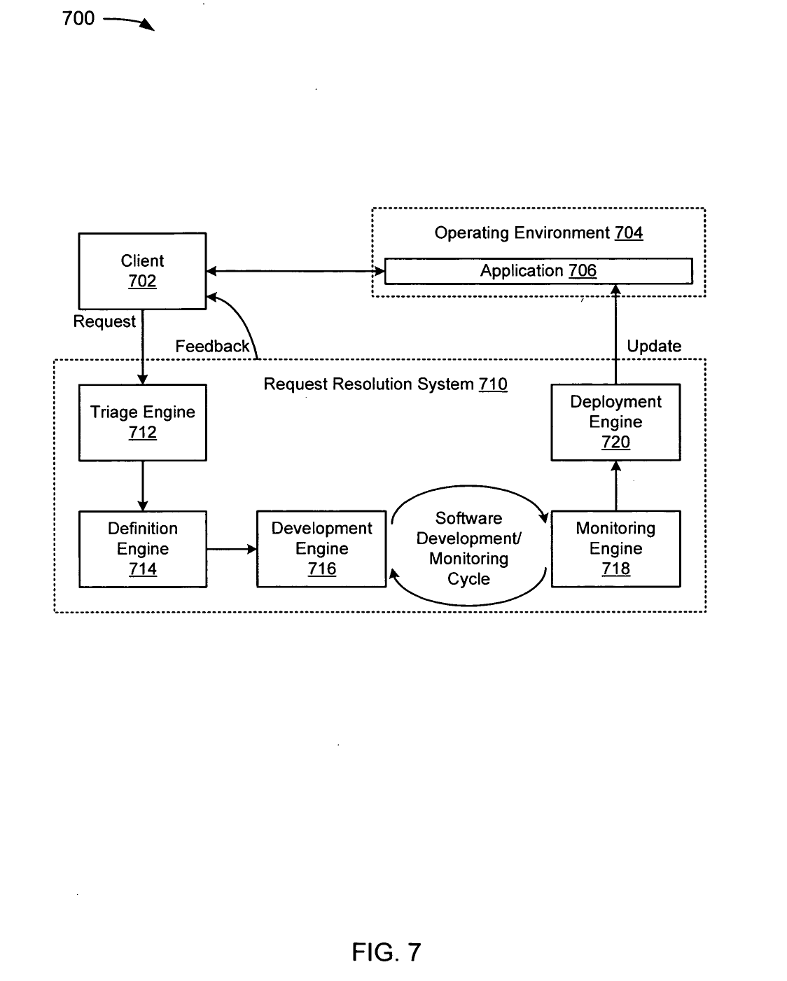

FIG. 7 depicts a conceptual view of a system 700 according to a non-limiting embodiment. In the example of FIG. 7, the system 700 includes a client 702, an operating environment 704, and a request resolution system 710. In the example of FIG. 7, the operating environment 704 includes an application 706. It may be noted that the client 702 may or may not include the operating environment 704, or vice versa.

In the example of FIG. 7, the request resolution system 710 includes a triage engine 712, a definition engine 714, a development engine 716, a monitoring engine 718, and a deployment engine 720. The engines, or a subset thereof, may or may not share a processor and memory (see, e.g., FIG. 8). The triage engine 712 is effective to receive a request associated with an application. The definition engine 714 is effective to define, in response to the request, a problem for solution by an appropriate agent. The development engine 716 is effective to facilitate development of a software solution to the problem by the appropriate agent. The monitoring engine 718 is effective to facilitate testing of the software solution. The deployment engine 720 is effective to update the application with the software solution.

In operation, the client 702 accesses the application 706 within the operating environment 704. The client submits a request to the request resolution system 710. The request may be submitted because, by way of example but not limitation, the client wishes some functionality existed in the application, the client identified a bug in the application, the client finds something aesthetically or otherwise displeasing, or for some other reason. At any stage of request resolution, the request resolution system 710 may provide feedback to the client, to make the client aware that the problem is request is being resolved. If necessary, the request resolution system 710 may or may not update the application as the client requested, after processing the request as follows.

In the example of FIG. 7, in operation, the request from the client 702 is received at the triage engine 712. The triage engine pre-processes the request for definition at the definition engine 714. The definition engine 714 defines a problem associated with the request and provides the problem to the development engine 716. The development engine 716 develops a software solution to the problem and the monitoring engine 718 tests the software solution to ensure it works for the intended effect. The development engine 716 and monitoring engine 718 may alternate multiple times in a software development/monitoring cycle, wherein a final version of the software solution is eventually produced. When the monitoring engine 718 determines that the software solution is ready for deployment, the deployment engine 720 updates the application 706.

FIG. 8 depicts a computer system 800 appropriate for use with one or more of the embodiments described above. The computer system 800 may be an optical device with a computer located therein, or a conventional computer system that can be used as a client computer system or a server computer system or as a web server computer system. The computer system 800 includes a computer 802, I/O devices 804, and a display device 806. The computer 802 includes a processor 808, a communications interface 810, memory 812, display controller 814, non-volatile storage 816, and I/O controller 818. The computer system 800 may be coupled to or include the I/O devices 804 and display device 806.

The computer 802 interfaces to external systems through the communications interface 810, which may include a modem or network interface. It will be appreciated that the communications interface 810 can be considered to be part of the computer system 800 or a part of the computer 802. The communications interface can be an analog modem, isdn modem, cable modem, token ring interface, satellite transmission interface (e.g. “direct PC”), or other interfaces for coupling a computer system to other computer systems.

The processor 808 may be, for example, a conventional microprocessor such as an Intel Pentium microprocessor or Motorola power PC microprocessor. In a typical architecture, the memory 812 is coupled to the processor 808 by a bus 820. The memory 812 can be dynamic random access memory (DRAM) and can also include static ram (SRAM). The bus 820 couples the processor 808 to the memory 812, also to the non-volatile storage 816, to the display controller 814, and to the I/O controller 818.

The I/O devices 804 can include a keyboard, disk drives, printers, a scanner, and other input and output devices, including a mouse or other pointing device. An optical system will typically include a lens assembly and imaging optics, as well. The display controller 814 may control in the conventional manner a display on the display device 816, which can be, by way of example but not limitation, a cathode ray tube (CRT) or liquid crystal display (LCD). The display controller 814 and the I/O controller 818 can be implemented with conventional well known technology.

The non-volatile storage 816 is often a magnetic hard disk, an optical disk, or another form of storage for large amounts of data. Some of this data is often written, by a direct memory access process, into memory 812 during execution of software in the computer 802. One of skill in the art will immediately recognize that the terms “machine-readable medium” or “computer-readable medium” includes any type of storage device that is accessible by the processor 808 and also encompasses a carrier wave that encodes a data signal.

The computer system 800 is one example of many possible computer systems which have different architectures. For example, personal computers based on an Intel microprocessor often have multiple buses, one of which can be an I/O bus for the peripherals and one that directly connects the processor 848 and the memory 852 (often referred to as a memory bus). The buses are connected together through bridge components that perform any necessary translation due to differing bus protocols.

A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software that includes a file management system, such as a disk operating system, which is part of the operating system software. One example of operating system software with its associated file management system software is the family of operating systems known as Windows®from Microsoft Corporation of Redmond, Wash., and their associated file management systems. Another example of operating system software with its associated file management system software is the Linux operating system and its associated file management system. The file management system is typically stored in the non-volatile storage 816 and causes the processor 808 to execute the various acts required by the operating system to input and output data and to store data in memory, including storing files on the non-volatile storage 816. The operating systems on portable devices, such as digital cameras, generally take up much less space than the operating systems of personal computers, and have less functionality.

As used herein, the term “embodiment” means an embodiment that serves to illustrate by way of example but not limitation.

It will be appreciated to those skilled in the art that the preceding examples and preferred embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention.

1. A computer-implemented method, comprising:
providing a wish button that is selectable within an operating environment;
receiving context associated with the operating environment when the wish button is selected;
alerting a development center of a request associated with the context;
funneling the request through one or more tollgates within the development center;
resolving the request at one of the one or more tollgates.

2. The method of claim 1, wherein the one or more tollgates include a triage tollgate, a definition tollgate, a development tollgate, a monitoring tollgate, and a deployment tollgate.

3. The method of claim 1 wherein the operating environment includes an application, and wherein the resolving the request at one of the one or more tollgates involves updating the application.

4. The method of claim 1, further comprising providing feedback at a plurality of the one or more tollgates.

5. The method of claim 1, further comprising categorizing the request using a contextual tree.

6. A computer-implemented method, comprising:
performing triage to prepare a request for funneling through a request resolution system, wherein the request is associated with an operating environment;
defining a problem associated with the request for resolution by an appropriate agent associated with the request resolution system;
informing the appropriate agent of the problem, wherein the appropriate agent develops a software solution in response to the problem;
testing the software solution at a monitoring module;
deploying the software solution at a deployment module.

7. The method of claim 6, further comprising receiving the request from a client with access to the operating environment.

8. The method of claim 6, wherein the request is associated with an application in the operating environment.

9. The method of claim 6, wherein the performing triage includes categorizing the request by importance.

10. The method of claim 6, wherein the defining a problem includes categorizing the problem using a contextual tree.

11. The method of claim 10, wherein the defining a problem includes assigning the appropriate agent based upon the categorization of the problem.

12. The method of claim 10, wherein the defining a problem includes grouping the problem with other related problems.

13. The method of claim 6, wherein the testing the software solution includes a software development/monitoring cycle.

14. The method of claim 6, wherein the deploying the software solution includes updating an application associated with the operating environment.

15. The method of claim 6, further comprising providing feedback regarding the state of request resolution.

16. A system, comprising:
a triage engine effective to receive a request associated with an application;
a definition engine, coupled to the triage engine, effective to define, in response to the request, a problem for solution by an appropriate agent;
a development engine, coupled to the definition engine, effective to facilitate development of a software solution to the problem by the appropriate agent;
a monitoring engine, coupled to the development engine, effective to facilitate testing of the software solution;
a deployment engine, coupled to the monitoring engine, effective to update the application with the software solution.

17. The system of claim 16, further comprising a client with access to an operating environment in which the application was running when the request was made.

18. The system of claim 16, further comprising a feedback engine, wherein the feedback engine provides information regarding which engine of the triage engine, definition engine, development engine, monitoring engine, and deployment engine, is resolving the request.

19. The system of claim 16, further comprising a control module that facilitates input of start times and end times at the engines.

20. The system of claim 16, wherein one or more of the engines includes an agent selected from the group of agents consisting of: a human agent, an artificial agent.
